(19) United States
(12) Patent Application Publication
(10) Pub. No.: US 2022/0398357 A1
(43) Pub. Date: Dec. 15, 2022

(54) WIRING DIAGRAM CREATION DEVICE, WIRING DIAGRAM CREATION METHOD AND WIRING DIAGRAM CREATION PROGRAM

(71) Applicant: Nippon Telegraph and Telephone Corporation, Tokyo (JP)

(72) Inventors: Shigehiro MATSUDA, Musashino-shi, Tokyo (JP); Yukihiro GOTO, Musashino-shi, Tokyo (JP); Ryuji HONDA, Musashino-shi, Tokyo (JP); Hiroyuki OSHIDA, Musashino-shi, Tokyo (JP)

(21) Appl. No.: 17/642,835

(22) PCT Filed: Sep. 18, 2019
(86) PCT No.: PCT/JP2019/036627

§ 371 Date: Mar. 14, 2022

(51) Int. Cl. G06F 30/18; G06T 11/20

(52) U.S. Cl. CPC G06F 30/18; G06T 11/206

(57) ABSTRACT

The purpose of the present disclosure is to make it possible to determine owners of cables from a positional relationship between the cables in an off-site equipment model acquired through a mobile mapping system (MMS). The present disclosure acquires cable models serving as solid models of cables extracted from three-dimensional point group data (S11), identifies a positional relationship of the cables from the cable models and determines owners of the cables from the positional relationship in accordance with a determination table defining a vertical relationship of the cables (S22), links information of the owners determined to the solid models, and creates a line diagram by using the cable models to which the information of the owners is linked.

### TECHNICAL FIELD

The present disclosure relates to a technique for determining and identifying owner information of cables stretched between utility poles in line diagram creation work for off-site equipment such as telecommunications equipment.

### BACKGROUND ART

There are techniques for generating an off-site equipment model from point group data acquired through a mobile mapping system (MMS) and acquiring positions of utility poles and states of cables stretched therebetween (refer to, for example, PTL 1).

However, while the states of the stretched cables are identified when the technique of PTL 1 is used, there is no method for automatically determining the owners of the cables, resulting in the problem of an inadequate line diagram.

### CITATION LIST

### Patent Literature

PTL 1: JP 2018-195240 A

### SUMMARY OF THE INVENTION

### Technical Problem

An object of the present disclosure is to make it possible to determine, in an off-site equipment model generated from a three-dimensional (3D) point group acquired through an MMS or the like, owners of cables from a positional relationship between the cables or a positional relationship between the cables and supporting wires, supporting poles, and the like.

### Means for Solving the Problem

In a case where cables of different owners are stretched between common utility poles, the cables of the different owners may be stretched at different heights. Thus, in the present disclosure, cable owners are determined by using this vertical relationship and a line diagram is created by using this.

A line diagram creation device according to the present disclosure includes a model determination unit configured to receive a cable model serving as a solid model of a cable extracted from three-dimensional point group data, identify a positional relationship of the cable from the cable model, determine an owner of the cable from the positional relationship, and link information of the owner determined to the cable model, and a line diagram creation unit configured to create a line diagram by using the cable model to which the information of the owner is linked by the model determination unit.

A line diagram creation method according to the present disclosure includes acquiring a cable model serving as a solid model of a cable extracted from three-dimensional point group data, identifying a positional relationship of the cable from the cable model, determining an owner of the cable from the positional relationship in accordance with a determination table defining a vertical relationship of cables, linking information of the owner determined to the solid model, and creating a line diagram by using the cable model to which the information of the owner is linked.

A line diagram creation program according to the present disclosure is a program for causing a computer to function as functional units included in the line diagram creation device according to the present disclosure and is a program for causing the computer to execute procedures included in the line diagram creation method according to the present disclosure.

### Effects of the Invention

According to the present disclosure, in an off-site equipment model generated from a 3D point group acquired through an MMS or the like, it is possible to determine owners of cables from a positional relationship between the cables and a positional relationship between supporting wires, supporting poles, and the like.

### BRIEF DESCRIPTION OF DRAWINGS

FIG. 1 illustrates an example of a solid model extracted from three-dimensional point group data.

FIG. 2 illustrates an example of a line diagram in which information of owners is not linked to cable models.

FIG. 3 illustrates an example of a line diagram in which information of owners is linked to cable models.

FIG. 4 illustrates a configuration example of a line diagram creation system according to a first embodiment.

FIG. 5 illustrates an example of a solid model of the first embodiment.

FIG. 6 illustrates an example of a determination table of the first embodiment.

FIG. 7 illustrates a flowchart illustrating an example of a representative model selection method of the first embodiment.

FIG. 8 illustrates a configuration example of a line diagram creation system according to a second embodiment.

FIG. 9 illustrates an example of a solid model of the second embodiment.

FIG. 10 illustrates an example of a determination table of the second embodiment.

FIG. 11 is a flowchart illustrating an example of a representative model selection method of the second embodiment.

FIG. 12 illustrates an configuration example of a line diagram creation system according to a third embodiment.

FIG. 13 illustrates an example of a solid model of the third embodiment.

FIG. 14 illustrates an example of a determination table of the third embodiment.

FIG. 15 is a flowchart of an example of a representative model selection method of the third embodiment.

FIG. 16 illustrates a configuration example of a line diagram creation system according to a fourth embodiment.

FIG. 17 illustrates an example of a solid model of the fourth embodiment.

FIG. 18 illustrates an example of a determination table of the fourth embodiment.

FIG. 19 is a flowchart illustrating an example of a representative model selection method of the fourth embodiment.

### DESCRIPTION OF EMBODIMENTS

Hereinafter, the embodiments of the present disclosure will be described in detail with reference to the drawings. Note that the present disclosure is not limited to the embodiments described below. These embodiments are just illustrative examples, and the present disclosure can be implemented in forms in which various modifications and improvements are added on the basis of knowledge of those skilled in the art. Note that components with the same reference signs in the specification and the drawings are assumed to be the same components.

Factors that cause the deterioration (deflection) of a utility pole may be attributable to not only the utility pole but surrounding structures as well. Thus, in order to identify utility pole deterioration factors, “information (line diagram) indicating the connection between the exact positions of utility poles and cables, and equipment with known cable internal angles and the like” for each owner of equipment is required.

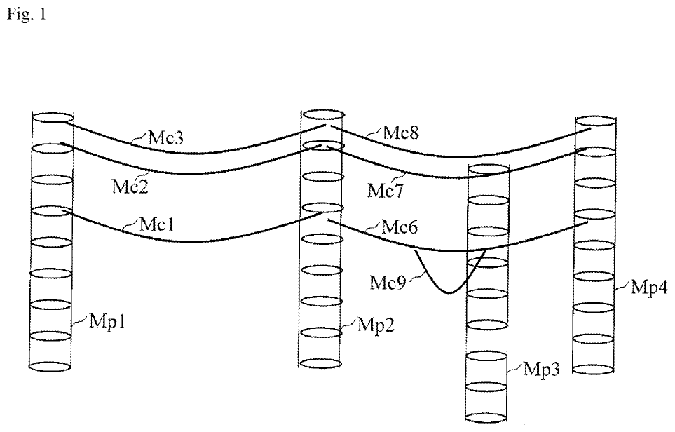

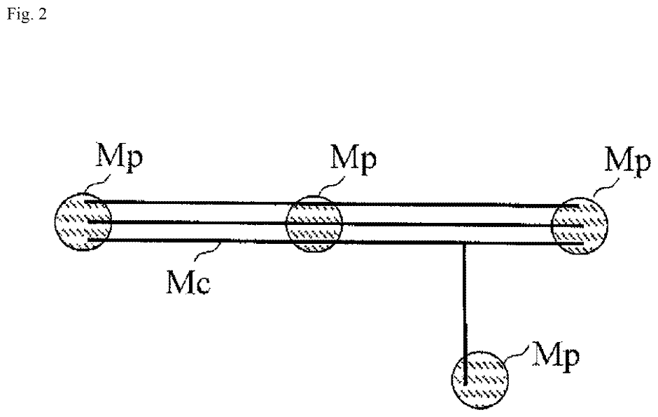

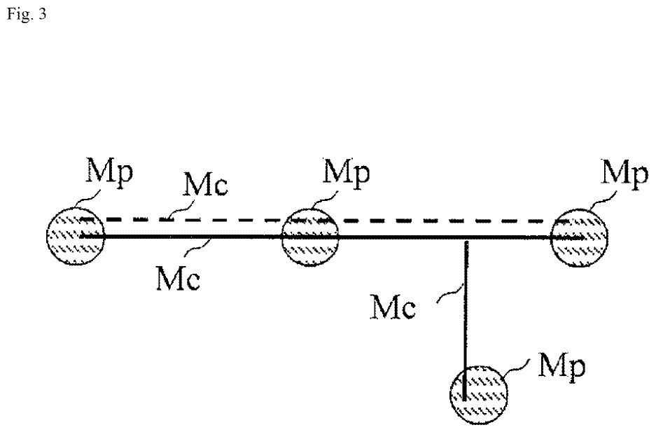

To create a line diagram, a method of utilizing, for creation, three-dimensional (3D) models, such as utility pole models Mp1 to Mp5 and cable models Mc1 to Mc9 automatically extracted from a 3D point group acquired through a mobile mapping system (MMS) known in the art (FIG. 1) is most likely used. However, in the method described above, a plurality of the cable models Mc may be generated between each of the utility pole models Mp as illustrated in FIG. 2, but there is no method for determining the owners of the actual cables corresponding to each of the cable models Mc. Thus, it is not possible to indicate in the diagram whether a cable is owned by a telecommunications company or owned by an electric power company using distinguishable lines, such as a solid line and a dashed line, such as illustrated in FIG. 3, making the diagram inadequate as a line diagram required for identifying utility pole deterioration factors.

In response, the present disclosure proposes a method for measuring a height of a cable model on a 3D point group to determine the owner. The following describes a method for determining the conditions and owner (telecommunications company and electric power company) of a cable model utilized in a line diagram. In the embodiments below, an example in which cables of an electric power company are connected to higher positions and cables of a telecommunications company are connected to lower positions will be described as one example.

### First Embodiment

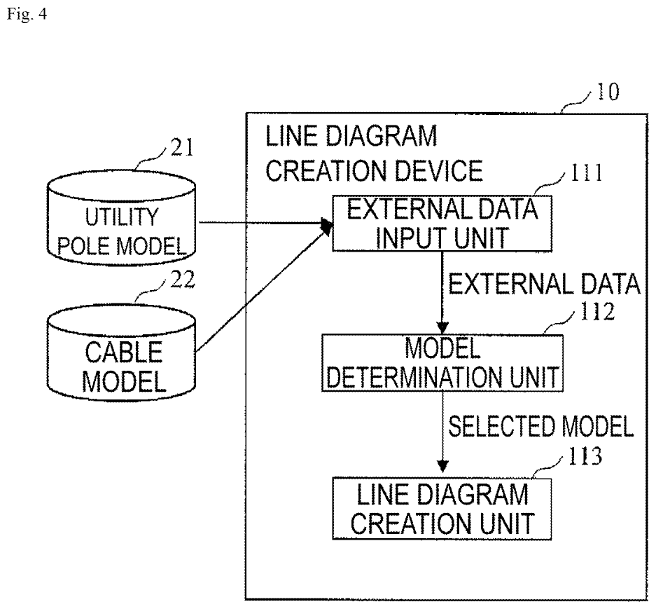

A selection method according to the present embodiment uses the lowest point of a cable model to compare the cable model with other cable models and make a determination. FIG. 4 illustrates a configuration example of a line diagram creation system according to the present embodiment. The line diagram creation system according to the present embodiment includes a line diagram creation device 10, a utility pole model database 21, and a cable model database 22. The utility pole model database 21 stores utility pole models. The cable model database 22 stores cable models.

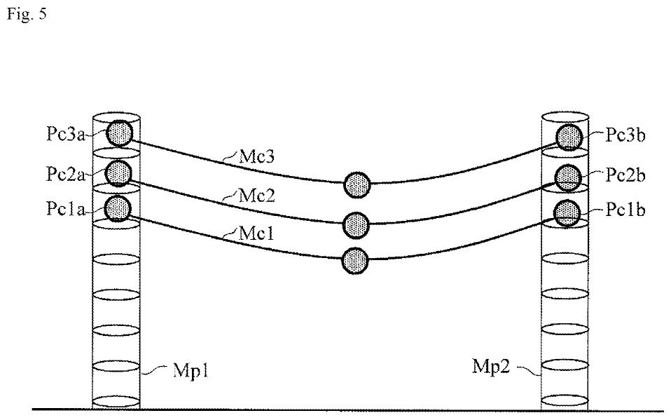

FIG. 5 illustrates an example of the utility pole models and the cable models of the present embodiment. The utility pole models Mp1 and Mp2 are 3D models of utility poles. The cable models Mc1, Mc2, and Mc3 are 3D models of cables. These 3D models can be generated using any technique, including the existing technique. Endpoints Pc1a and Pc1b of the cable model Mc1, endpoints Pc2a and Pc2b of the cable model Mc2, and endpoints Pc3a and Pc3b of the cable model Mc3 are all positioned on the utility pole models Mp1 and Mp2. A range of the cable models Mc1, Mc2, and Mc3 having a common combination of endpoints in this way is referred to as an identical span.

An external data input unit 111 has a function of inputting external data including the utility pole models and the cable models into the line diagram creation device 10.

A model determination unit 112, in the selection method of the present embodiment, has a function of determining owners of the cables corresponding to the cable models, and selecting a representative model for each owner.
A line diagram creation unit 113 has a function of creating a line diagram from the models output from the model determination unit 112.

In the present embodiment, there are two owners, namely a telecommunications company and an electric power company, and the model determination unit 112 selects a telecommunications company representative model and an electric power company representative model. The line diagram creation unit 113 uses the telecommunications company representative model and the electric power company representative model to create a line diagram. Thus, the present embodiment indicated below can create a line diagram indicating whether a cable is owned by the telecommunications company or owned by the electric power company using distinguishable lines, such as a solid line and a dashed line, such as illustrated in FIG. 3.

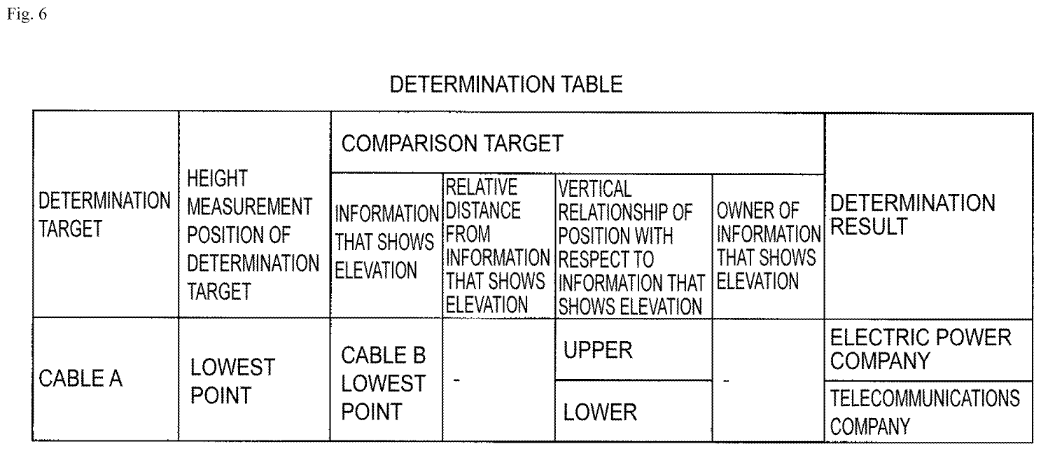

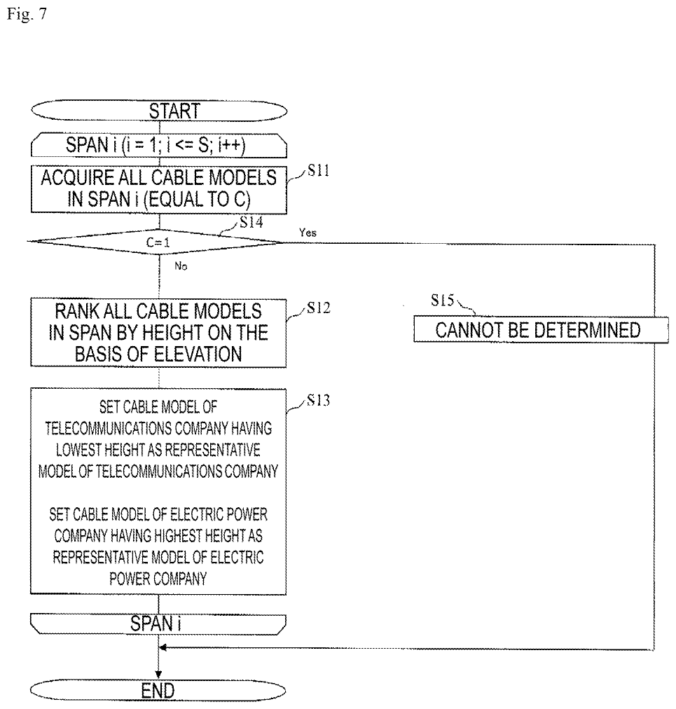

The model determination unit 112 of the present embodiment determines whether the cable model is that of the electric power company or the telecommunications company for all cable models in the identical span by a determination table illustrated in FIG. 6. FIG. 7 illustrates an example of a flowchart. Here, in the diagram, “S” indicates the number of all spans, and “C” indicates the number of cable models belonging to a span i.

S11: All cable models in span i are acquired. For example, the cable models Mc1, Mc2, and Mc3 are acquired. Here, the cable models Mc1, Mc2, and Mc3 are all present between the utility pole models Mp1 and Mp2. Thus, in a cable span in which the endpoints are utility poles, when both of the endpoints of the cables serving as endpoints are the same utility poles, it is determined that the cable models are in the identical span.

S12: All cable models in the span are ranked by height on the basis of elevation. For example, according to the determination table, a height measurement position of the determination target is the “lowest point.” In this case, the heights at the lowest points of the cable models Mc3, Mc2, and Mc1 are measured. In FIG. 5, the cable models Mc3, Mc2, and Mc1 are higher in this order. Note that, when there are cable models having the same height, the cable model may be selected utilizing either the cable model having a lower GPS prediction error during acquisition of the point group serving as the basis of the cable model or the cable model having a longer model length.

S13: According to the determination table, the cable models positioned higher are those of the electric power company and the cable models positioned lower are those of the telecommunications company. Thus, in the present embodiment, determinations are made as follows.

Method for Selecting Model Utilized in Line Diagram as Having Telecommunications Company as Owner

The cable model Mc1 having the lowest elevation at the lowest point of the cable model among the cable models Mc1, Mc2, and Mc3 in the identical span is set as the telecommunications company representative model. Here, the “telecommunications company representative model” is the model utilized in the line diagram with the assumption that the telecommunications company is the owner. Thus, information indicating that the owner is the telecommunications company is linked to the cable model Mc1 and the model is output as the telecommunications company representative model.

Method for Selecting Model to be Utilized in Line Diagram as Having Electric Power Company as Owner

The cable model Mc3 having the highest elevation at the lowest point of the cable model among the cable models Mc1, Mc2, and Mc3 in the identical span is set as the electric power company representative model. The “electric power company representative model” is the model to be utilized in the line diagram with the assumption that the electric power company is the owner. Thus, information indicating that the owner is the electric power company is linked to the cable model Mc3 and the model is output as the electric power company representative model.

Note that, between steps S11 and S12, whether or not the number C of cable models belonging to the span i is 1 may be determined (S14). In a case where there is only one cable model extracted from the 3D point group in the identical span (No in step S14), the model determination unit 112 omits steps S12 and S13 as a determination cannot be made (S15).

As described above, in the present embodiment, the owner of a cable can be determined using a 3D model of the cable, making it possible to automatically create a line diagram required for identification of utility pole deterioration factors from the 3D model.

### Second Embodiment

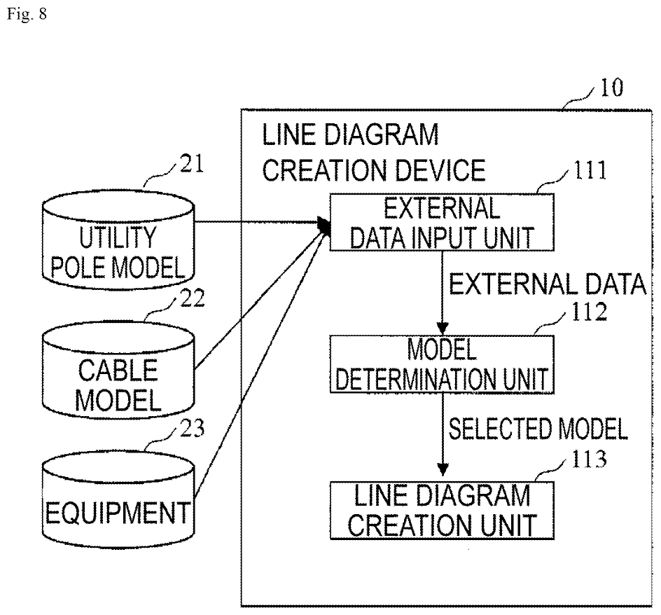

A selection method according to the present embodiment uses an endpoint of a cable model to compare the cable model with other cable models and make a determination. FIG. 8 illustrates a configuration example of a line diagram creation system according to the present embodiment. The line diagram creation system according to the present embodiment includes the line diagram creation device 10, the utility pole model database 21, the cable model database 22, and an equipment database 23. The utility pole model database 21 stores utility pole models. The cable model database 22 stores cable models. The equipment database 23 stores equipment data.

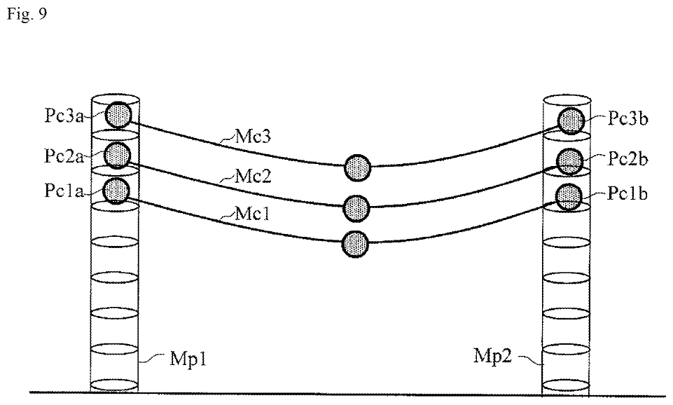

FIG. 9 illustrates an example of the utility pole models and the cable models of the present embodiment. The utility pole models Mp1 and Mp2 are 3D models of utility poles. The cable models Mc1, Mc2, and Mc3 are 3D models of cables. The equipment data is data of information related to equipment, such as cables and utility poles, and includes the locations of the utility poles and the information of the owners of the cables stretched between the utility poles.

The external data input unit 111 has a function of inputting external data including the utility pole models, the cable models, and an equipment database (DB) into the line diagram creation device 10.

The model determination unit 112, in the selection method of the present embodiment, has a function of determining the owners of the cables corresponding to the cable models, and selecting a representative model for each owner.
The line diagram creation unit 113 has a function of creating a line diagram from the models output from the model determination unit 112.

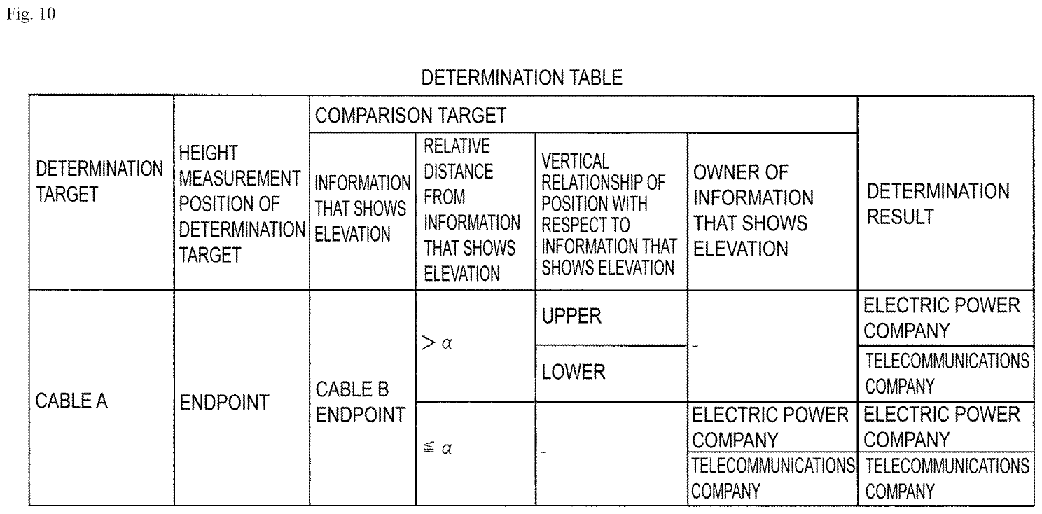

The model determination unit 112 of the present embodiment determines whether the model is that of the electric power company or the telecommunications company for all cable models in the identical span by a determination table illustrated in FIG. 10. Here, a relative distance is the relative distance between models in a height direction, that is, a vertical direction. Each point of the 3D point group data includes positional information, and thus the relative distance between models can be readily converted to a relative distance in real space. Thus, the relative distance in real space may be used.

In the present embodiment, in a case where the cable models are disposed close together, the determination is made that the owners are the same. On the other hand, in a case where the cable models are disposed far apart, the determination is made that the owners are different. In the present embodiment, when the relative distance is a or less, the determination is made that the models are close together, and when the relative distance is greater than a, the determination is made that the models are far apart. These values of “a” are configurable, and the setting value for determining that models are close together and the setting value for determining that the models are far apart need not be the same and may be different.

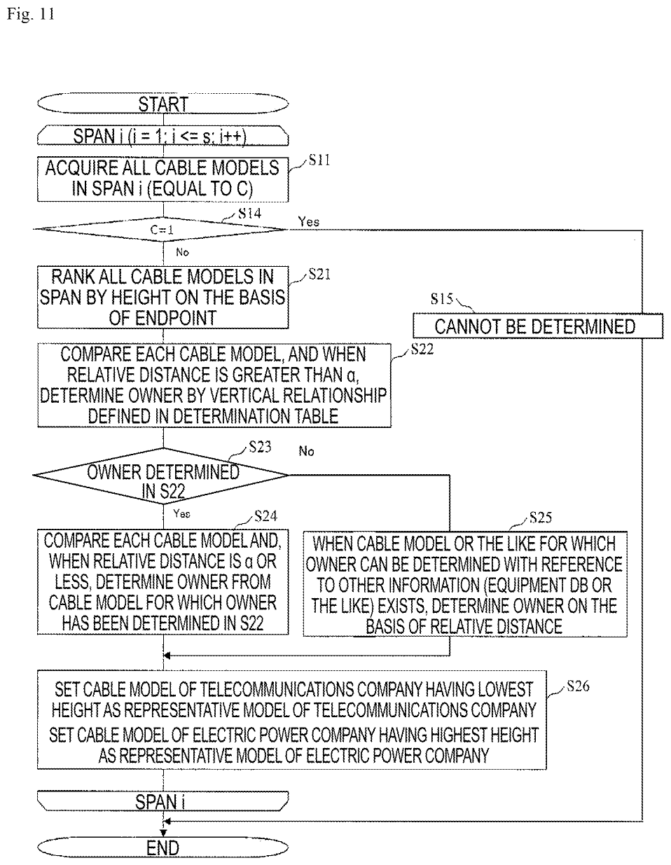

FIG. 11 illustrates an example of a flowchart of the present embodiment. In the diagram, “S” indicates the number of cable models in all spans, and “C” indicates the number of cable models belonging to the span i. Steps S11, S14, S15 are the same as those in the first embodiment. In the present embodiment, step S14 is followed by steps S21 to S26.

S21: According to the determination table, the height measurement position of the determination target is an endpoint. Thus, all cable models in the span are ranked by height on the basis of the endpoints Pc1a, Pc1b, Pc2a, Pc2b, Pc3a, and Pc3b. In the example of FIG. 9, the cable models Mc3, Mc2, and Mc1 are higher in this order.

Here, when the heights of both endpoints of a cable model differ, either the low endpoint, the high endpoint, or the average of both endpoints may be used for calculation. Further, when there are cable models having the same height, the cable model may be selected by utilizing either the cable model having a lower GPS prediction error during acquisition of the point group serving as the basis of the cable model or the cable model having a longer model length.

S22: Each cable model is compared, and when the relative distance is greater than a, the owner is determined by the vertical relationship. For example, the cable model Mc1 is disposed lower than the cable model Mc3. When the distance between the endpoint Pc1a and the endpoint Pc3a is greater than the setting value α, the owner of the cable model Mc1 is determined to be the telecommunications company, and the owner of the cable model Mc3 is determined to be the electric power company. As a result, the fact that the owner is the telecommunications company is linked to the cable model Mc1, and the fact that the owner is the electric power company is linked to the cable model Mc3.

S23: When the owner can be determined in step S22, the flowchart proceeds to step S24. When the owner cannot be determined in step S22, the flowchart proceeds to step S25. For example, when the relative distance between the endpoint Pc1a and the endpoint Pc3a is less than or equal to the set value α, the flowchart proceeds to step S25.

S24: Each cable model is compared and, when the relative distance is less than or equal to the set value α the owner is determined from the cable model for which the owner has been determined in step S22. For example, when the relative distance between the endpoint Pc2a and the endpoint Pc3a is less than or equal to the set value α, the owner of the cable corresponding to the cable model Mc2 is determined to be the owner of the cable corresponding to the cable model Mc3. In this case, the fact that the owner is the electric power company is linked to the cable model Mc2. On the other hand, when the relative distance between the endpoint Pc2a and the endpoint Pc1a is less than or equal to the set value α, the owner of the cable corresponding to the cable model Mc2 is determined to be the owner of the cable corresponding to the cable model Mc1. In this case, the fact that the owner is the telecommunications company is linked to the cable model Mc2.

S25: When a cable model for which the owner can be determined with reference to other information, such as equipment data, exists, the owner is determined on the basis of the relative distance. For example, when the fact that the owner of the cables in the identical span is the telecommunications company is stored in the equipment database 23, the owner of the cables corresponding to the cable models Mc1, Mc2, and Mc3 is determined to be the telecommunications company. As a result, information that the owner is the telecommunications company is linked to the cable models Mc1, Mc2, and Mc3.

S26: Following the execution of step S24 or S25, step S26 indicated below is executed.

Method for Selecting Representative Model of Telecommunications Company

The cable model having the lowest elevation at the endpoint of the cable model among the cable models having the telecommunications company as the owner in the identical span is set as the representative model of telecommunications company. For example, when the owner of the cables corresponding to the cable models Mc1 and Mc2 is the telecommunications company, the cable model Mc1 is selected as the representative model of the telecommunications company. Thus, the cable model Mc1 linked to the fact that the owner is the telecommunications company is output as the telecommunications company representative model.

Method for Selecting Representative Model of Electric Power Company

The cable model having the highest elevation at the endpoint of the cable model among the cable models having the electric power company as the owner in the identical span is set as the representative model of electric power company. For example, when the owner of the cables corresponding to the cable models Mc2 and Mc3 is the telecommunications company, the cable model Mc3 is selected as the representative model of the telecommunications company. Thus, the cable model Mc3 linked to the fact that the owner is the electric power company is output as the electric power company representative model.

Note that step S24 may be executed after step S25. This makes it possible to determine the owner of each cable even if many cables exist in the identical span. The same holds true for the embodiments described hereinafter.

As described above, in the present embodiment, the owner of a cable can be determined using a 3D model of the cable, making it possible to automatically create a line diagram required for identification of utility pole deterioration factors from the 3D model.

### Third Embodiment

The positions of a cable endpoint and an endpoint of a supporting wire or supporting pole may be disposed close together by the owner. For example, when a cable of the telecommunications company is disposed in a relatively low position, the cable endpoint and the endpoint of the supporting wire or the supporting pole of the telecommunications company are disposed close together. Here, a selection method according to the present embodiment compares the endpoint of the cable model with the supporting wire or the supporting pole model to make a determination. The present embodiment differs from the second embodiment in that the comparison target is the supporting wire or supporting pole model. Below, the characteristics of the present embodiment will be described.

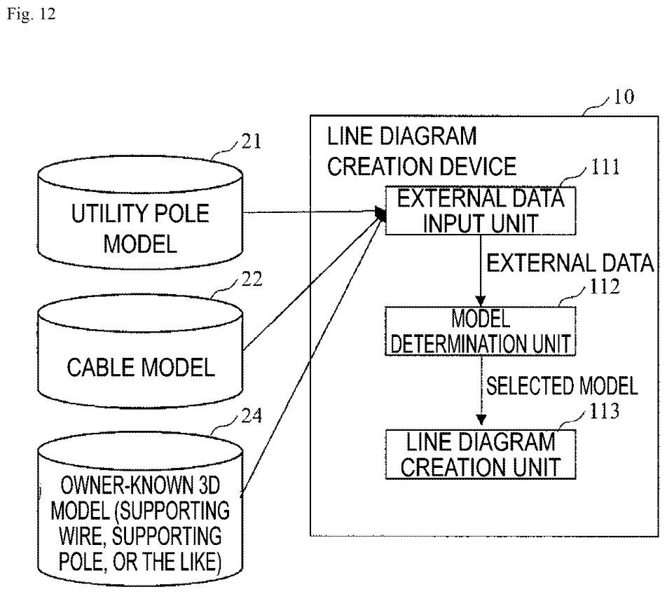

FIG. 12 illustrates a configuration example of a line diagram creation device according to the present embodiment. A line diagram creation system according to the present embodiment includes the line diagram creation device 10, the utility pole model database 21, the cable model database 22, and an owner-known 3D model database 24.

The utility pole model database 21 stores utility pole models and owner information. The cable model database 22 stores cable models. The owner-known 3D model database 24 stores the 3D models and owner information of the supporting wires, the supporting poles, and the like for which the owners are known.

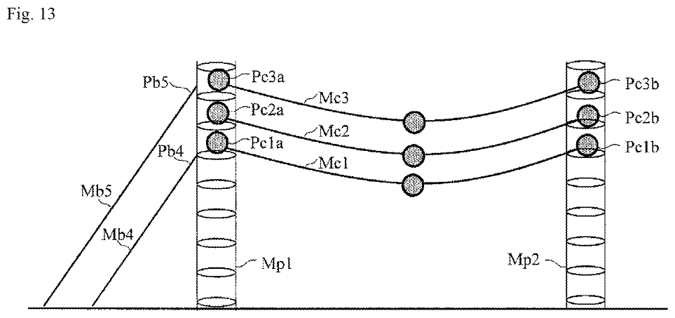

FIG. 13 illustrates an example of the utility pole models and the cable models of the present embodiment. The utility pole models Mp1 and Mp2 are 3D models of utility poles. The cable models Mc1, Mc2, and Mc3 are 3D models of cables. Supporting wire or supporting pole models Mb4, Mb5 are 3D models of the supporting wires or the supporting poles connected to a utility pole.

The external data input unit 111 has a function of inputting external data such as 3D model and equipment data into the line diagram creation device 10. The external data includes, for example, data of 3D models output from the utility pole model database 21, the cable model database 22, and the owner-known 3D model database 24.

The model determination unit 112, in the selection method of the present embodiment, has a function of determining the owners of the cables corresponding to the cable models, and selecting models to be utilized in the line diagram.
The line diagram creation unit 113 has a function of creating a line diagram from the models output from the model determination unit 112.

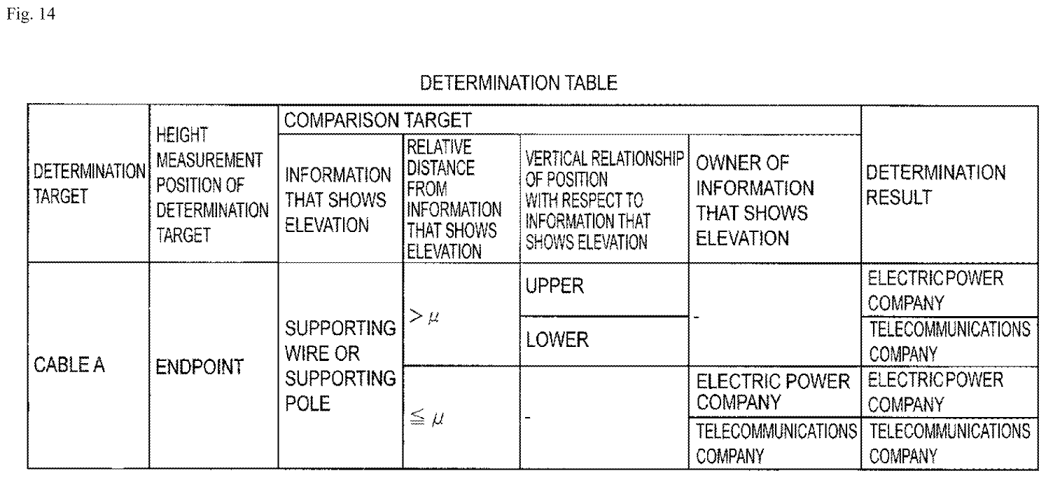

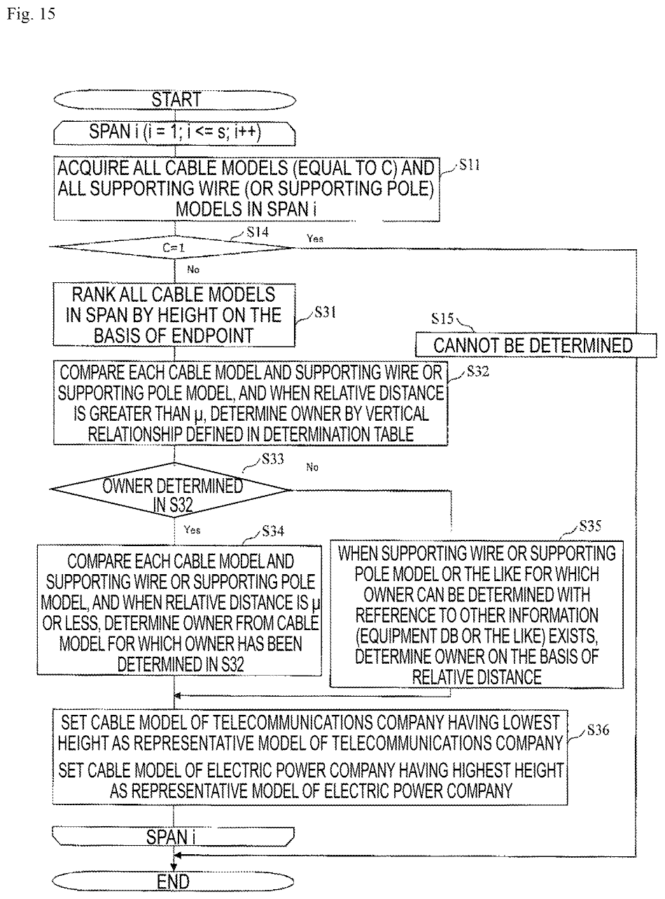

The model determination unit 112 of the present embodiment determines whether the model is that of the electric power company or the telecommunications company for all cable models in the identical span by a determination table illustrated in FIG. 14. FIG. 15 illustrates an example of a flowchart of the present embodiment. In the diagram, “S” indicates the number of cable models in all spans, and “C” indicates the number of cable models belonging to the span i.

In the present embodiment, in step S11, in addition to all cable models (equal to C) in the span i, the models of all supporting wires and supporting poles connected to the utility poles on both ends of the span are acquired. Steps S14, S15 are the same as those in the first embodiment. In the present embodiment, step S14 is followed by steps S31 to S36.

S31: According to the determination table, the height measurement position of the determination target is an endpoint. Thus, all cable models in the span are ranked by height on the basis of the endpoints Pc1a, Pc1b, Pc2a, Pc2b, Pc3a, and Pc3b. In FIG. 13, in the identical span, the cable models Mc3, Mc2, and Mc1 are higher in this order.

Here, when the heights of both endpoints of a cable model differ, either the low endpoint, the high endpoint, or the average of both endpoints may be used for calculation. Further, when there are cable models having the same height, the cable model may be selected by utilizing either the cable model having a lower GPS prediction error during acquisition of the point group serving as the basis of the cable model or the cable model having a longer model length.

S32: Each cable model Mc1, Mc2, and Mc3 and supporting wire or supporting pole model Mb4, Mb5 are compared, and when the relative distance is greater than the setting value μ, the owner is determined by the vertical relationship with reference to the determination table.

For example, when the relative distance between the endpoint Pc3a of the cable model Mc3 and the endpoint Pb4 of the supporting wire or supporting pole model Mb4 is greater than the setting value μ and the endpoint Pc3a is higher than the endpoint Pb4, the owner of the cable corresponding to the cable model Mc3 disposed higher is determined to be the electric power company. When the relative distance between the endpoint Pc1a of the cable model Mc1 and the endpoint Pb5 of the supporting wire or supporting pole model Mb5 is greater than the setting value μ and the endpoint Pc1a is lower than the endpoint Pb5, the owner of the cable corresponding to the cable model Mc1 disposed lower is determined to be the telecommunications company.

S33: When the owner can be determined in step S32, the flowchart transitions to step S34. When the owner cannot be determined in step S32, the flowchart transitions to step S35.

S34: Each cable model Mc1, Mc2, Mc3 and the supporting wire or supporting pole model Mb4, Mb5 are compared and, when the relative distance is the setting value μ or less, the determination is made from the cable model for which the owner has been determined in step S32. For example, when the relative distance between endpoint Pc3a of the cable model Mc3, the endpoint Pc2a of the cable model Mc2, and the endpoint Pb5 of the supporting wire or supporting pole model Mb5 is the setting value μ or less, and the owner of the cable model Mc3 is the electric power company, the owner of the cable corresponding to the cable model Mc2 is determined to be the electric power company.

S35: When a supporting wire or supporting pole model or the like for which the owner can be determined with reference to other information (equipment DB or the like) exists, the owner is determined on the basis of the relative distance. For example, when the fact that the owner of the supporting wire or supporting pole model Mb4 is the telecommunications company is stored in the owner-known 3D model database 24, the owner of the cables corresponding to the cable models Mc1, Mc2, Mc3 is determined to be the telecommunications company.

S36: Following execution of steps S33 and S34, step S36 indicated below is executed.

Method for Selecting Representative Model of Telecommunications Company

The cable model having the lowest elevation at the endpoint of the cable model among the cable models having the communications company as the owner in the identical span is set as the representative model of telecommunications company.

Method for Selecting Representative Model of Electric Power Company

The cable model having the highest elevation at the endpoint of the cable model among the cable models of the electric power company in the identical span is set as the representative model of electric power company.

As described above, in the present embodiment, the owner of a cable can be determined using a 3D model of the cable, making it possible to automatically create a line diagram required for identification of utility pole deterioration factors from the 3D model. Note that, in the present embodiment, the configuration of the second embodiment may be further provided.

Note that, in step S34, similarly to step S24 of the second embodiment, when the relative distance between the endpoints of the cable models is less than or equal to the set value α, the determination may be made from the cable model for which the owner has been determined in step S32.

### Fourth Embodiment

A selection method according to the present embodiment uses an endpoint of a cable model to compare the cable model with a known 3D model (the ground, a number plate, or the like) and make a determination. The present embodiment differs from the second embodiment in that the comparison targets are various known 3D models defined in the determination table. Below, the characteristics of the present embodiment will be described.

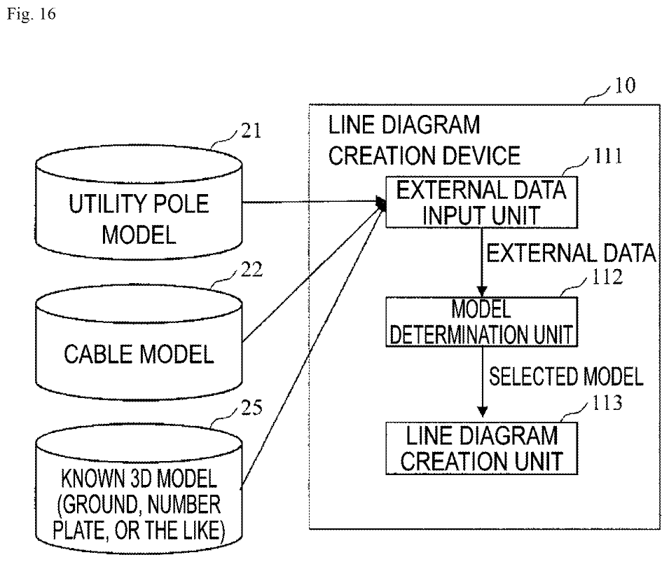

FIG. 16 illustrates a configuration example of a line diagram creation system according to the present embodiment. A line diagram creation system according to the present embodiment includes the line diagram creation device 10, the utility pole model database 21, the cable model database 22, and a known 3D model database 25.

The utility pole model database 21 stores utility pole models. The cable model database 22 stores cable models. The known 3D model database 25 stores 3D models of structures for which the owners are known and owner information. Here, the structures include any structure such as the ground, a number plate, or the like.

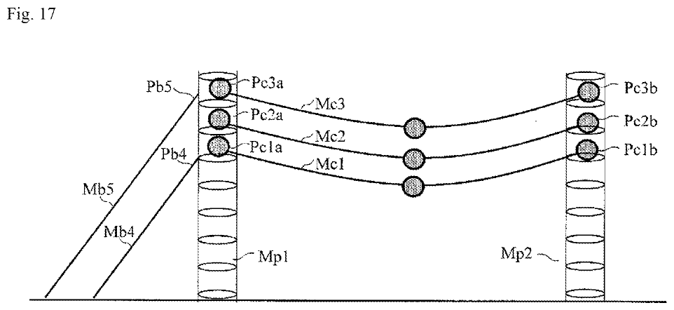

FIG. 17 illustrates an example of the utility pole models and the cable models of the present embodiment. The utility pole models Mp1 and Mp2 are 3D models of utility poles. The cable models Mc1, Mc2, and Mc3 are 3D models of cables. The supporting wire or supporting pole models Mb4, Mb5 are 3D models of the supporting wires or the supporting poles connected to a utility pole.

The external data input unit 111 has a function of inputting external data such as 3D model data and equipment data into the line diagram creation device 10. The external data includes, for example, data of 3D models output from the utility pole model database 21, the cable model database 22, and the known 3D model database 25.

The model determination unit 112, in the selection method of the present embodiment, has a function of determining the owners of the cables corresponding to the cable models, and selecting models to be utilized in the line diagram.
The line diagram creation unit 113 has a function of creating a line diagram from the models output from the model determination unit 112.

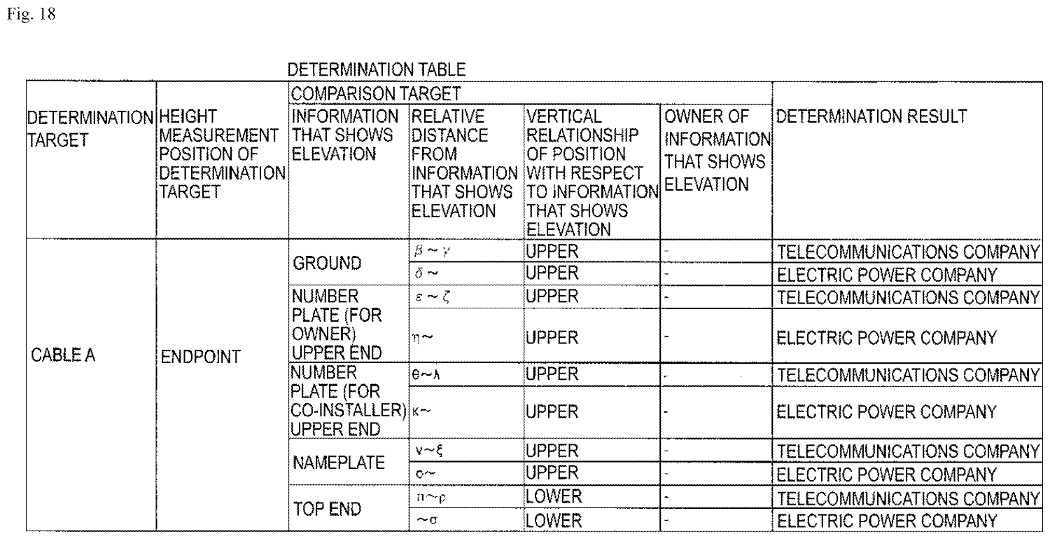

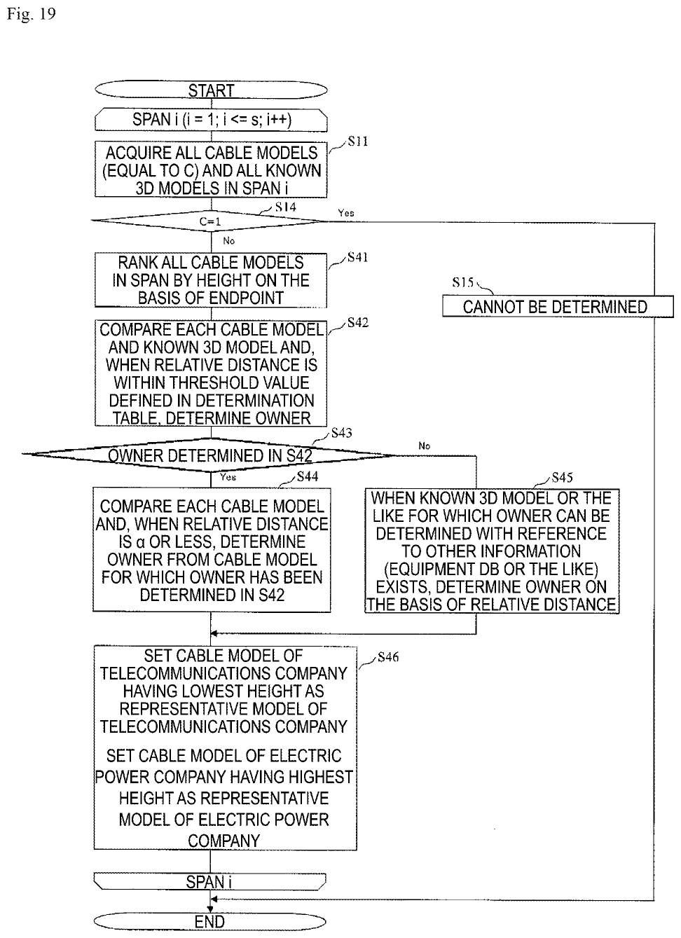

The model determination unit 112 of the present embodiment determines whether the cable model is that of the telecommunications company or the electric power company for all cable models in the identical span by a determination table illustrated in FIG. 18. FIG. 19 illustrates an example of a flowchart of the present embodiment. In the diagram, “S” indicates the number of cable models in all spans, and “C” indicates the number of cable models belonging to the span i.

In the present embodiment, in step S11, all 3D models for which the owner is known are acquired for all cable models (equal to C) in the span i with reference to the known 3D model database 25. Steps S14, S15 are the same as those in the first embodiment. In the present embodiment, step S14 is followed by steps S41 to S46.

S41: According to the determination table, the height measurement position of the determination target is an endpoint. Therefore, all cable models in the span are ranked by height on the basis of the endpoints Pc1a, Pc1b, Pc2a, Pc2b, Pc3a, and Pc3b. In FIG. 17, the cable models Mc3, Mc2, and Mc1 are higher in this order.

Here, when the heights of both endpoints of a cable model differ, either the low endpoint, the high endpoint, or the average of both endpoints may be used for calculation. Further, when there are cable models having the same height, the cable model may be selected utilizing either the cable model having a lower GPS prediction error during acquisition of the point group serving as the basis of the cable model or the cable model having a longer model length.

S42: When each of the cable models Mc1, Mc2, and Mc3 and the known 3D models acquired from the known 3D model database 25 are compared and the relative distance between the cable model and a known 3D model is within a range defined in the determination table, the determination is made that the owner is the owner defined in the determination table.

For example, when the distance from the endpoints Pc1a and Pc1b of the cable model Mc1 to the ground is within a range of from β to γ and the distance from the endpoints Pc3a and Pc3b of the cable model Mc3 to the ground is δ or greater, it is determined that the owner of the cable corresponding to the cable model Mc1 is the telecommunications company and the owner of the cable corresponding to the cable model Mc3 is the electric power company.

S43: The flowchart transitions to step S44 for a cable model for which the owner can be determined in step S42, and transitions to step S45 for a cable model for which the owner cannot be determined in step S42.

S44: Each cable model is compared and, when the relative distance is less than or equal to the set value α, determination is made from the cable model for which the owner has been determined in S42. For example, when the relative distance between the endpoint Pc2a and the endpoint Pc3a is less than or equal to the set value α, the owner of the cable corresponding to the cable model Mc2 is determined to be the owner of the cable corresponding to the cable model Mc3.

S45: When a known 3D model or the like for which the owner can be determined with reference to other information (equipment DB or the like) exists, the owner is determined on the basis of the relative distance. For example, the relative distance between the nameplate disposed on the utility pole model Mp1 and the endpoint Pc2a of the cable model Mc2 is found with reference to the owner-known 3D model database 24. Then, as long as the endpoint Pc2a is higher than the nameplate and the relative distance is within a range of from ν to ξ the owner of the cable corresponding to the cable model Mc2 is determined to be the telecommunications company and, as long as the endpoint Pc2a is higher than the nameplate and the relative distance is greater than o, the owner of the cable corresponding to the cable model Mc2 is determined to be the communications company.

S36: Following the execution of steps S43 and S44, step S46 indicated below is executed.

Method for Selecting Representative Model of Telecommunications Company

The cable model having the lowest elevation at the endpoint of the cable model among the cable models in the identical span is set as the representative model of telecommunications company.

Method for Selecting Representative Model of Electric Power Company

The cable model having the highest elevation at the endpoint of the cable model among the cable models in the identical span is set as the representative model of telecommunications company.

As described above, in the present embodiment, the owner of a cable can be determined by using a 3D model of the cable, making it possible to automatically create a line diagram required for identification of utility pole deterioration factors from the 3D model.

Note that, in step S44, similarly to step S34 of the third embodiment, when the endpoints of each cable model Mc1, Mc2, and Mc3 and the endpoints of the supporting wire or supporting pole models Mb4, Mb5 are compared and the relative distance is the setting value μ or less, determination may be made from the cable model for which the owner has been determined in step S32.

Note that the device in the present disclosure can be achieved by a computer and a program, and it is possible to record the program in a recording medium or to provide the program through a network. Further, in the above-described embodiment, an example in which cables of the electric power company are connected to higher positions and cables of the telecommunications company are connected to lower positions is described, but the present disclosure is not limited thereto. For example, the cables of the electric power company may be connected to lower positions and the cables of the telecommunications company may be connected to higher positions. Further, in the present disclosure, an example is indicated in which the owner is the telecommunications company or the electric power company, but the owner may be any two companies. Further, embodiments of the second and subsequent embodiments are not limited to the owners being two owners and may be applied to three or more owners.
According to the present disclosure, in an off-site equipment model acquired by an MMS, owners of cables can be made distinguishable from a positional relationship between the cables.
According to the present disclosure, a line diagram acquired by an MMS can be automatically created in a line diagram that satisfies the requirements for identifying utility pole deterioration factors (indicating connections between equipment for every owner of equipment).
According to the present disclosure, in line diagram creation work, an owner of a cable can be determined from an off-site equipment model acquired from point group data, resulting in an advantageous effect of improving the efficiency of the creation work.

### INDUSTRIAL APPLICABILITY

The present disclosure can be applied in the information communication industry.

### REFERENCE SIGNS LIST

10 Line diagram creation device
111 External data input unit
112 Model determination unit
113 Line diagram creation unit
21 Utility pole model
22 Cable model
23 Equipment database
24 Owner-known 3D model database
25 Known 3D model database

1. A line diagram creation device comprising:
a model determination unit comprising a computer processor and configured to receive a cable model serving as a solid model of a cable extracted from three-dimensional point group data, identify a positional relationship of the cable from the cable model, determine an owner of the cable from the positional relationship, and link information of the owner determined to the cable model; and
a line diagram creation unit comprising the computer processor and configured to create a line diagram by using the cable model to which the information of the owner is linked by the model determination unit

2. The line diagram creation device according to claim 1, wherein
the model determination unit is configured to
calculate a distance in a height direction from an endpoint of the cable model to a reference position determined in advance,
determine the owner of the cable corresponding to the cable model in accordance with a determination table defining the owner in accordance with a vertical relationship between a plurality of the cables and the distance, and
link the information of the owner determined to the cable model.

3. The line diagram creation device according to claim 2, wherein
a plurality of the cable models are disposed in an identical span with a common combination of two of the endpoints,
the reference position is a position of an endpoint of a cable model of the plurality of the cable models disposed in the identical span, and
the model determination unit is configured to
calculate the distance by calculating a relative distance between a plurality of the endpoints of the plurality of the cable models in the height direction,
for at least one of the plurality of the cable models with the distance exceeding a first setting value determined in advance, determine the owner of the cable individually in accordance with the determination table, and
link the information of the owner of the cable determined to a corresponding cable model of the at least one cable model exceeding the first setting value.

4. The line diagram creation device according to claim 2, wherein
the endpoint of the cable model is connected to a utility pole model serving as a solid model of a utility pole, and the utility pole model is connected to a supporting wire or supporting pole model serving as a solid model of a supporting wire or a supporting pole,
the reference position is a connection position between the supporting wire or supporting pole model and the utility pole model, and
the model determination unit is configured to
calculate a distance in the height direction from the endpoint of the cable model to the connection position,
for at least one cable model of a plurality of the cable models with the distance exceeding a second setting value determined in advance, determine the owner of the cable individually in accordance with the determination table, and
link information of the owner of the cable determined to a corresponding cable model of the at least one cable model exceeding the second setting value.

5. The line diagram creation device according to claim 1, wherein
a plurality of the cable models are disposed in an identical span with a common combination of two of the endpoints, and
the model determination unit is configured to
calculate a distance between a plurality of the endpoints of the plurality of the cable models in the height direction, and
when the distance between the endpoint of a cable model of the plurality of the cable models and the endpoint of another cable model of the plurality of the cable models to which the information of an owner is linked is less than or equal to a third setting value determined in advance, link, to the other cable model, an owner identical to the owner linked to the cable model for which the distance between the endpoints is the third setting value or less.

6. The line diagram creation device according to claim 1, wherein
the model determination unit is configured to
determine a vertical relationship between lowest points of a plurality of the cable models disposed in an identical span with a common combination of two of the endpoints of the cable model,
determine an owner of a cable disposed at the highest position and an owner of a cable disposed at the lowest position in the identical span,
link the information of the owner of the cable disposed at the highest position to a cable model disposed at the highest position among the plurality of the cable models, and
link the information of the owner of the cable disposed at the lowest position to a cable model disposed at the lowest position among the plurality of the cable models.

7. A line diagram creation method comprising:
acquiring a cable model serving as a solid model of a cable extracted from three-dimensional point group data;
identifying a positional relationship of the cable from the cable model;
determining an owner of the cable from the positional relationship in accordance with a determination table defining a vertical relationship of a plurality of the cables and the owner;
linking information of the owner determined to the solid model; and
creating a line diagram by using the cable model to which the information of the owner is linked.

8. A line diagram creation program for causing a computer to operate as a plurality of functional units included in the line diagram creation device according to claim 1.
